(19) United States
(12) Patent Application Publication
(10) Pub. No.: US 2016/0205378 A1
(43) Pub. Date: Jul. 14, 2016

(54) MULTIMODE DEPTH IMAGING

(71) Applicants: Amir Nevet, Haifa (IL); David Cohen, Nesher (IL); Giora Yahav, Haifa (IL); Dani Daniel, Haifa (IL)

(72) Inventors: Amir Nevet, Haifa (IL); David Cohen, Nesher (IL); Giora Yahav, Haifa (IL); Dani Daniel, Haifa (IL)

(21) Appl. No.: 14/592,725

(22) Filed: Jan. 8, 2015

(51) Int. Cl. H04N 13/02

(52) U.S. Cl. CPC H04N 13/0239; H04N 13/0257

(57) ABSTRACT

An imaging system includes first and second imaging arrays separated by a fixed distance, first and second drivers, and a modulated light source. The first imaging array includes a plurality of phase-responsive pixels distributed among a plurality of intensity-responsive pixels; the modulated light source is configured to emit modulated light in a field of view of the first imaging array. The first driver is configured to modulate the light output from the modulated light source and synchronously control charge collection from the phase-responsive pixels. The second driver is configured to recognize positional disparity between the intensity-responsive pixels of the first imaging array and corresponding intensity-responsive pixels of the second imaging array.

### BACKGROUND

Stereo-optical imaging is a technique for imaging a three-dimensional contour of a subject. In this technique, the subject is observed concurrently from two different points of view, which are separated by a fixed horizontal distance. The amount of disparity between corresponding pixels of the concurrent images provides an estimate of distance to the subject locus imaged onto the pixels. Stereo-optical imaging offers many desirable features, such as good spatial resolution and edge detection, tolerance to ambient light and patterned subjects, and a large depth-sensing range. However, this technique is computationally expensive, provides a limited field of view, and is sensitive to optical occlusions and to misalignment of imaging components.

### SUMMARY

This disclosure provides, in one embodiment, an imaging system having first and second imaging arrays separated by a fixed distance, first and second drivers, and a modulated light source. The first imaging array includes a plurality of phase-responsive pixels distributed among a plurality of intensity-responsive pixels; the modulated light source is configured to emit modulated light in the field of view of the first imaging array. The first driver is configured to modulate the light output from the modulated light source and synchronously control charge collection from the phase-responsive pixels. The second driver is configured to recognize positional disparity between the intensity-responsive pixels of the first imaging array and corresponding intensity-responsive pixels of the second imaging array.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in this disclosure.

### BRIEF DESCRIPTION OF THE DRAWINGS

FIG. 1 is a schematic, plan view of an example environment in which an imaging system is used to image a subject.

FIG. 2 shows aspects of an example right imaging array of the imaging system of FIG. 1.

FIG. 3 shows an example transmission spectrum of an optical filter associated with the right imaging array of FIG. 2.

FIG. 4 illustrates an example depth-sensing method enacted via the imaging system of FIG. 1.

### DETAILED DESCRIPTION

Aspects of this disclosure will now be described with reference to the drawings listed above. Components, process steps, and other elements that may be substantially the same are identified coordinately and are described with minimal repetition. It will be noted, however, that elements identified coordinately may also differ to some degree. It will be further noted that the drawings are schematic and generally not drawn to scale. Rather, the various drawing scales, aspect ratios, and numbers of components shown in the figures may be purposely distorted to make certain features or relationships easier to see.

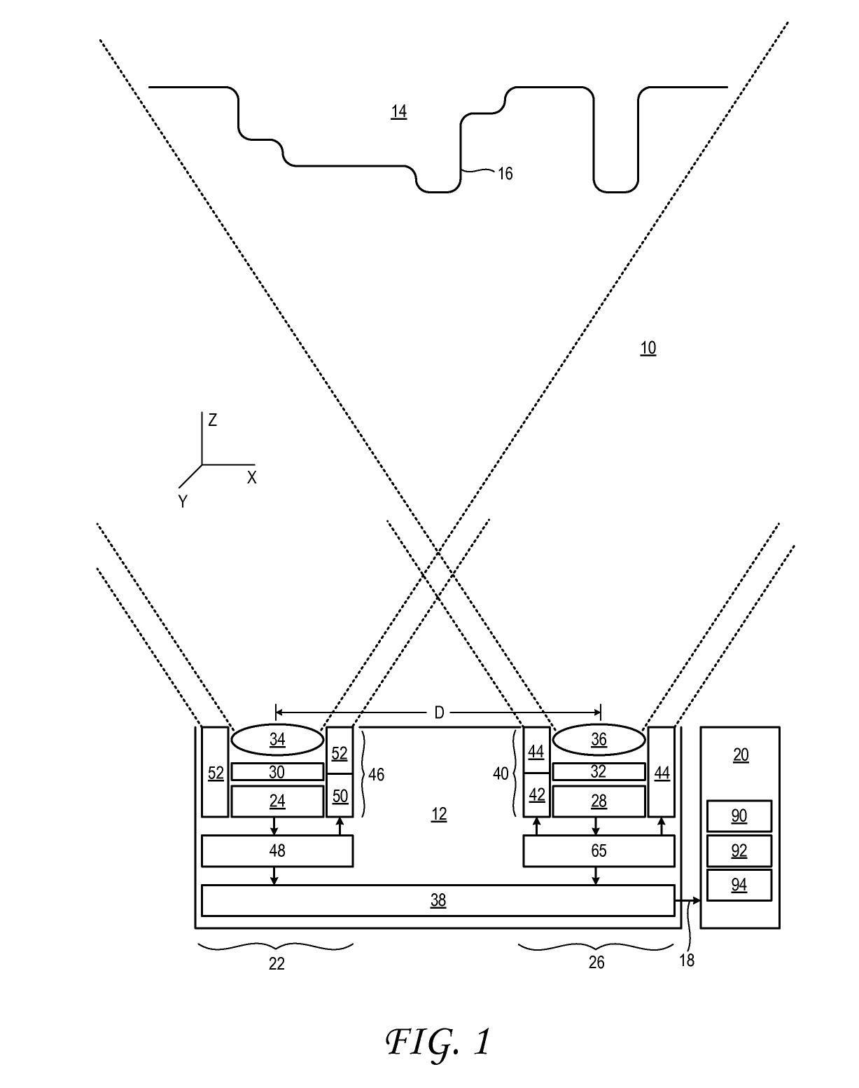

FIG. 1 is a schematic, plan view of an example environment 10, in which an imaging system 12 is used to image a subject 14. The terms ‘imaging,’ ‘to image,’ etc., refer herein to the acquisition of flat images, depth images, grey-scale images, color images, infrared (IR) images, static images, and time-resolved series of static images (i.e., video).

Imaging system 12 in FIG. 1 is directed toward a contoured forward surface 16 of subject 14; this is the surface being imaged. In scenarios in which the subject is movable relative to the imaging system, or vice versa, a plurality of subject surfaces may be imaged. The schematic representation of the subject in FIG. 1 is not intended to be limiting in any sense, for this disclosure applies to the imaging of many different kinds of subjects: interior and exterior subjects, background and foreground subjects, and animate subjects such as human beings, for example.

Imaging system 12 is configured to output image data 18 representing subject 14. The image data may be transmitted to image receiver 20—a personal computer, home entertainment system, tablet, smart phone, or game system, for example. The image data may be transmitted via any suitable interface—a wired interface such as a universal serial bus (USB) or system bus, or a wireless interface such as a Wi-Fi or Bluetooth interface, for example. The image data may be used in image receiver 20 for various purposes—to construct a map of environment 10 for virtual-reality (VR) applications, or to record gestural input from a user of the image receiver, for example. In some embodiments, imaging system 12 and image receiver 20 may be integrated together in the same device—e.g., a wearable device with near-eye display componentry.

Imaging system 12 includes two cameras: right camera 22 with right imaging array 24, and left camera 26 with left imaging array 28. The right and left imaging arrays are separated by a fixed horizontal distance D. It will be understood that the designations ‘right’ and ‘left’ are applied merely for ease of component identification in the illustrated configurations. However, this disclosure is equally consistent with configurations that are mirror images of those illustrated. In other words, the designations ‘right’ and ‘left’ can be exchanged throughout to yield an equally acceptable description. Likewise, the cameras and associated componentry may be vertically or obliquely separated and designated ‘top’ and ‘bottom’ instead of ‘right’ and ‘left,’ without departing from the spirit or scope of this disclosure.

Continuing in FIG. 1, an optical filter is arranged forward of each of the left and right imaging arrays: optical filter 30 is arranged forward of the right imaging array, and optical filter 32 is arranged forward of the left imaging array. Each optical filter is configured to pass only those wavelengths useful for imaging onto the associated imaging array. In addition to the optical filters, an objective lens system is arranged forward of each of the right and left imaging arrays: objective lens system 34 is arranged forward of the right imaging array, and objective lens system 36 is arranged forward of the left imaging array. Each objective lens system collects light over a range of field angles and directs such light onto the associated imaging array, mapping each field angle to a corresponding pixel of the imaging array. In one embodiment, the range of field angles accepted by the objective lens systems covers 60 degrees in the horizontal and 40 degrees in the vertical, for both cameras. Other field-angle ranges are contemplated as well. In general, the objective lens systems may be configured so that the right and left imaging arrays have overlapping fields of view, enabling subject 14 (or a portion thereof) to be sighted within the overlap region.

In the configuration described above, image data from intensity-responsive pixels of right imaging array 24 and of left imaging array 28 (right and left images, respectively) may be combined via a stereo-vision algorithm to yield a depth image. The term ‘depth image’ refers herein to a rectangular array of pixels (Xᵢ, Yᵢ) with a depth value Zᵢ associated with each pixel. In some variants, each pixel of a depth image may also have one or more associated brightness or color values—e.g., a brightness value for each of red, green, and blue light.

To compute a depth image from a pair of stereo images, pattern-matching may be used to identify corresponding (i.e., matching) pixels of the right and left images, which, based on their disparity, provide a stereo-optical depth estimate. More specifically, for each pixel of the right image, a corresponding (i.e., matching) pixel of the left image is identified. Corresponding pixels are assumed to image the same locus of the subject. Positional disparity ΔX, ΔY is then recognized for each pair of corresponding pixels. The positional disparity expresses the shift in pixel position of a given subject locus in the left image relative to the right image. If imaging system 12 is oriented horizontally, then the depth coordinate Zᵢ of any locus is a function of the horizontal component ΔX of the positional disparity and of various fixed parameter values of imaging system 12. Such fixed parameter values include the distance D between the right and left imaging arrays, the respective optical axes of the right and left imaging arrays, and the focal length f of the objective lens systems. In imaging system 12, the stereo-vision algorithm is enacted in stereo-optical driver 38, which may include a dedicated automatic feature extraction (AFE) processor for pattern matching.

In some embodiments, right and left stereo images may be acquired under ambient-light conditions, with no additional illumination source. In such a configuration, the amount of available depth information is a function of the 2D feature density of the imaged surface 16. If the surface is featureless (e.g., smooth and all the same color), then no depth information will be available. To address this deficit, imaging system 12 optionally includes a structured light source 40. The structured light source is configured to emit structured light in the field of view of the left imaging array; it includes a high-intensity light-emitting diode (LED) emitter 42 and a redistribution optic 44. The redistribution optic is configured to collect and angularly redistribute the light from the LED emitter, such that it projects, with defined structure, from an annular-shaped aperture surrounding objective lens system 36 of left camera 26. The resulting structure in the projected light may include a regular pattern of bright lines or dots, for instance, or a pseudo-random pattern to avoid aliasing issues. In one embodiment, LED emitter 42 may be configured to emit visible light—e.g., green light matching the quantum-efficiency maximum for silicon-based imaging arrays. In another embodiment, the LED emitter may be configured to emit IR or near-IR light. In this manner, structured light source 40 may be configured to impart imagable structure on virtually any featureless surface, to improve the reliability of stereo-optical imaging.

Although a depth image of subject 14 may be computed via stereo-optical imaging, as described above, this technique admits of several limitations. First and foremost, the required pattern-matching algorithm is computationally expensive, typically requiring a dedicated processor or application-specific integrated circuit (ASIC). Furthermore, stereo-optical imaging is prone to optical occlusions, provides no information on featureless surfaces (unless used with a structured light source) and is quite sensitive to misalignment of the imaging components—both static misalignment caused by manufacturing tolerances, and dynamic misalignment caused by temperature changes and by mechanical flexion of imaging system 12.

To address these issues while providing still other advantages, right camera 22 of imaging system 12 is configured to function as a time-of-flight (ToF) depth camera as well as a flat-image camera. To this end, the right camera includes modulated light source 46 and ToF driver 48. To support ToF imaging, right imaging array 24 includes a plurality of phase-responsive pixels in addition to a complement of intensity-responsive pixels.

Modulated light source 46 is configured to emit modulated light in the field of view of right imaging array 24; it includes a solid-state IR or near-IR laser 50 and an annular projection optic 52. The annular projection optic is configured to collect the emission from the laser and to redirect the emission such that it projects from an annular-shaped aperture surrounding objective lens system 34 of right camera 22.

ToF driver 48 may include an image signal processor (ISP). The ToF driver is configured to modulate the light output from modulated light source 46 and synchronously control charge collection from the phase-responsive pixels of right imaging array 24. The laser may be pulse- or continuous-wave (CW) modulated. In embodiments where CW modulation is used, two or more frequencies may be superposed, to overcome aliasing in the time domain.

In some configurations and scenarios, right camera 22 of imaging system 12 may be used by itself to provide a ToF depth image of subject 14. In contrast to stereo-optical imaging, the ToF approach is relatively inexpensive in terms of compute power, is not subject to optical occlusions, does not require a structured light on featureless surfaces, and is relatively insensitive to alignment issues. In addition, ToF imaging typically exhibits superior motion robustness because it operates according to a ‘global shutter’ principle. On the other hand, a typical ToF camera is somewhat more limited in depth-sensing range, is less tolerant of ambient light and of specularly reflective surfaces, and may be confounded by multi-path reflections.

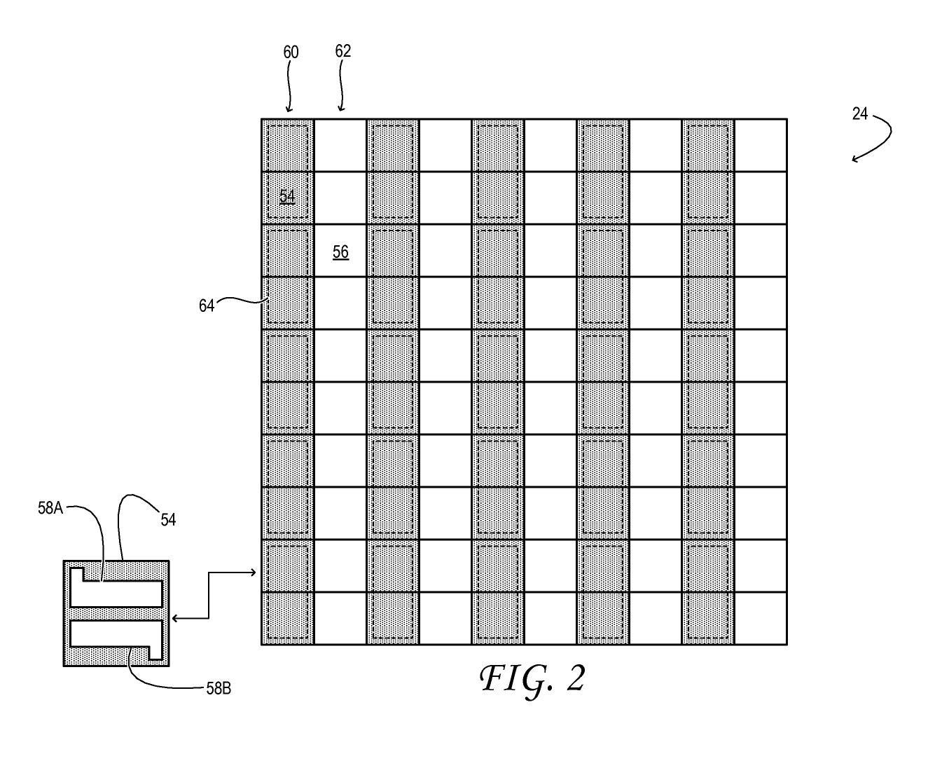

The deficits noted above, both for stereo-optical and ToF imaging, are addressed in the configurations and methods disclosed herein. In sum, this disclosure provides hybrid depth-sensing modes based partly on the ToF imaging and partly on stereo-optical imaging. Leveraging the unique advantages of both forms of depth imaging, these hybrid modes are facilitated by the specialized pixel structure of right imaging array 24, which is represented in FIG. 2.

FIG. 2 shows aspects of right imaging array 24. Here the individual pixel elements are shown enlarged and reduced in number. The right imaging array includes a plurality of phase-responsive pixels 54 distributed among a plurality of intensity-responsive pixels 56. In one embodiment, the right imaging array may be a charge-coupled device (CCD) array. In another embodiment, the right imaging array may be a complementary metal-oxide semiconductor (CMOS) array. Phase-responsive pixels 54 may be configured for gated, pulsed ToF imaging, or otherwise configured for continuous-wave (CW), lock-in ToF imaging.

In the embodiment shown in FIG. 2, each phase-responsive pixel 54 includes a first pixel element 58A, an adjacent second pixel element 58B, and may include additional pixel elements not shown in the drawing. Each phase-responsive pixel element may include one or more finger gates, transfer gates and/or collection nodes epitaxially formed on a semiconductor substrate. The pixel elements of each phase-responsive pixel may be addressed so as to provide two or more integration periods synchronized to the emission from the modulated light source. The integration periods may differ in phase and/or total integration time. Based on the relative amount of differential (and in some embodiments common mode) charge accumulated on the pixel elements during the different integration periods, the distance out to a locus of the subject may be assessed.

As noted above, the addressing of pixel elements 58A and 58B is synchronized to the modulated emission of modulated light source 46. In one embodiment, laser 50 and first pixel element 58A are energized concurrently, while second pixel element 58B is energized 180° out of phase with respect to the first pixel element. Based on the relative amount of charge accumulated on the first and second pixel elements, the phase angle of the reflected light pulse received in the imaging pixel array is computed versus the probe modulation. From that phase angle, the distance out to the corresponding locus may be computed, based on the known speed of light in air.

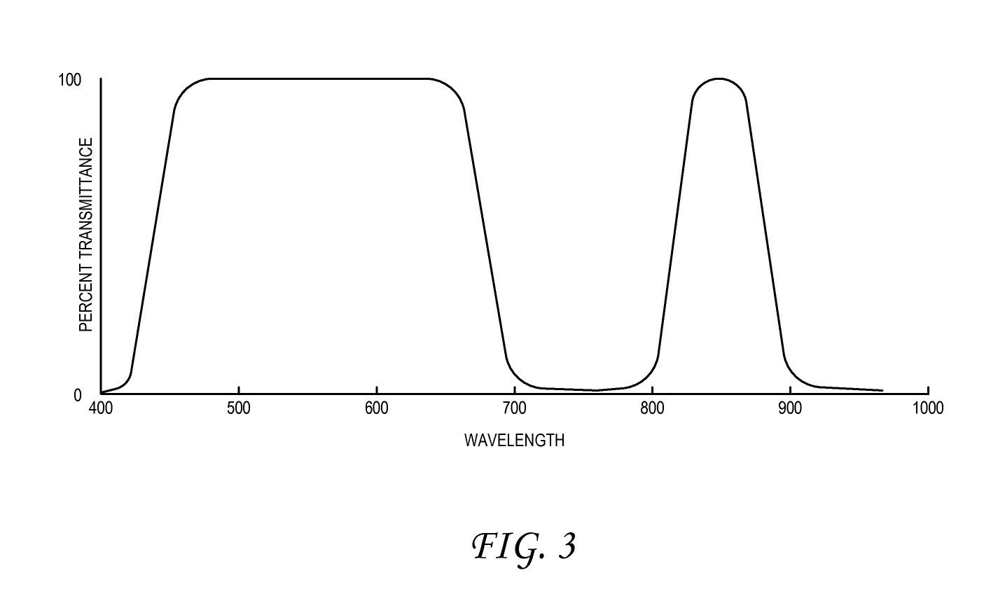

In the embodiment shown in FIG. 2, contiguous phase-responsive pixels 54 are arranged in parallel rows 60, between intervening, mutually parallel rows 62 of contiguous intensity-responsive pixels 56. Although the drawing shows a single intervening row of intensity-responsive pixels between adjacent rows of phase-responsive pixels, other suitable configurations may include two or more intervening rows. In embodiments in which stereo-optical imaging is enacted using visible light, each phase-responsive pixel may include an optical filter layer (represented as shading in FIG. 2) configured to block wavelengths outside (e.g., below) the emission band of the modulated light source. In such embodiments, optical filter 30 may include a dual-passband filter configured to transmit visible light and to block infrared light outside of the emission band of modulated light source 46. A representative transmission spectrum of optical filter 30 is shown in FIG. 3.

In the embodiment of FIG. 2, a group 64 of two contiguous phase-responsive pixels of a given row is addressed concurrently to provide plural charge storages for the group. This configuration may provide three or four charge storages. Plural charge storage enables ToF information to be captured with minimal impact of motion of the subject or scene. Each charge storage collects information at a difference function of depth. Plural charge storage may also enable super-resolution of the 2D images for a camera in motion, improving registration.

The orientation of right imaging array 24 may differ in the different embodiments of this disclosure. In one embodiment, the parallel rows of phase- and intensity-responsive pixels may be arranged vertically for better ToF resolution, especially when two or more phase-responsive pixels 54 are addressed together (for plural charge storage). This configuration also reduces the aspect ratio of pixel groups 64. In other embodiments, the parallel rows may be arranged horizontally, for finer recognition of horizontal disparity.

Although FIG. 2 shows a uniform distribution of pixels across right imaging array 24, this aspect is by no means necessary. In some embodiments, intensity-responsive pixels 56 of the right imaging array are included only in portions of the right imaging array that image an overlap section between the fields of view of the right and left imaging arrays. The balance of the right imaging array may include only phase-responsive pixels 54. In this embodiment, the overlap-imaging portion of the right imaging array may be arranged on a left portion of the right imaging array. The width of the overlap-imaging portion may be determined based on a predetermined, most-probable depth range of subject 14 relative to imaging system 12, for an expected application of the imaging system.

In contrast to right imaging array 24, left imaging array 28 may be an array of intensity-responsive pixels only. In one embodiment, the left imaging array is a red-green-blue (RGB) color pixel array. Accordingly, the intensity-responsive pixels of the second imaging array include red-, green-, and blue-transmissive filter elements. In another embodiment, the left imaging array may be an unfiltered monochrome array. In some embodiments, the pixels of the left imaging array are at least somewhat sensitive to the IR or near-IR. This configuration would enable stereo-optical imaging in darkness, for example. In lieu of an additional ToF driver, a generic left camera driver 65 may be used to interrogate the left imaging array. In some embodiments, the pixel-wise resolution of the left imaging array may be greater than that of the right imaging array. The left imaging array may be that of a high-resolution color camera, for instance. In this type of configuration, imaging system 12 may provide not only a useful depth image, but also a high-resolution color image, to image receiver 20.

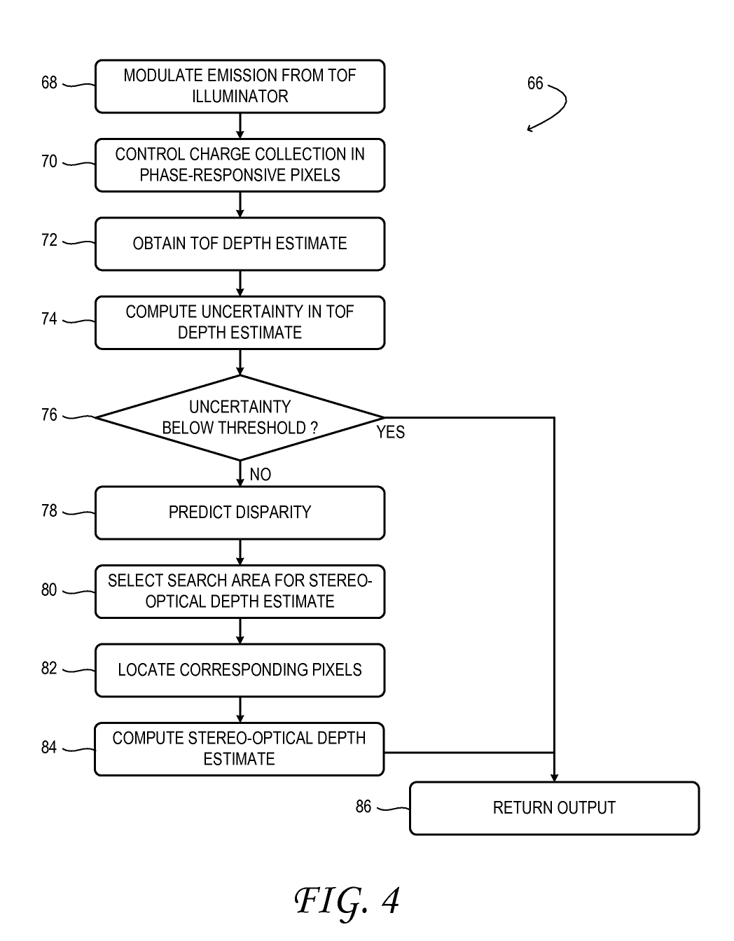

FIG. 4 illustrates an example depth-imaging method 66 enacted in an imaging system having right and left imaging arrays separated by a fixed distance and configured to image a subject. The illustrated steps of the method may be enacted for each of a plurality of surface points of the subject, and these points may be selected in a variety of ways, depending on the embodiment. In some embodiments, the selected surface points are points imaged onto the intensity-responsive pixels of right imaging array 24 (every, every other, every third intensity-responsive pixel, etc.). In other embodiments, the plurality of surface points may be a dense or sparse subset of feature points automatically recognized in image data from the intensity-responsive pixels of the right imaging array—e.g., when the subject is illuminated by ambient light. In still other embodiments, the plurality of surface points may be points specifically illuminated by structured light from a structured light source of the imaging system. In some implementations of method 66, this plurality of surface points may be rastered through in sequence. In other implementations, two or more subsets of the plurality of surface points may be dispatched each to its own processor core and processed in parallel.

At 68 of method 66, emission from a modulated light source of the imaging system is modulated via pulse or CW modulation. Synchronously, at 70, charge collection from phase-responsive pixels of the right imaging array of the imaging system is controlled. These actions furnish, at 72, a ToF depth estimate for each of the surface points of the subject. At 74 an uncertainty in the ToF depth estimate is computed for each surface point. Briefly, the phase-responsive pixels of the right imaging array may be addressed via different gating schemes, resulting in a distribution of ToF depth estimates. The width of the distribution is a surrogate for the uncertainty of the ToF depth estimate at the current surface point.

At 76 it is determined whether the uncertainty in the ToF depth estimate is below a predetermined threshold. If the uncertainty is below the predetermined threshold, then stereo-optical depth estimation for the current surface point is determined to be unnecessary, and omitted for the current surface point. In this scenario, the ToF depth estimate is provided (at 86, below) as the final depth output, reducing the necessary compute effort. If the uncertainty is not below the predetermined threshold, then the method continues to 78, where the positional disparity between right and left stereo images is predicted on the basis of the ToF depth estimate for that point and of known imaging-system parameters.

At 80 a search area of the left image is selected based on the predicted disparity. In one embodiment, the search area may be a group of pixels centered around a target pixel. The target pixel may be shifted, relative to a given pixel of the right imaging array, by an amount equal to the predicted disparity. In one embodiment, the uncertainty computed at 74 controls a size of the searched subset corresponding to that point. Specifically, a larger subset around the target pixel may be searched when the uncertainty is great, and a smaller subset may be searched when the uncertainty is small. This reduces unnecessary computation effort in subsequent pattern matching.

At 82 a pattern matching algorithm is executed within the selected search area of the left image to locate an intensity-responsive pixel of the left imaging array corresponding to the given intensity-responsive pixel of the right imaging array. This process yields a refined disparity between corresponding pixels. At 84 the refined disparity between intensity-responsive pixels of the right imaging array and corresponding intensity-responsive pixels of the left imaging array is recognized, in order to furnish a stereo-optical depth estimate, for each of the plurality of surface points of the subject.

At 86, the imaging system returns an output based on the ToF depth estimate and on the stereo-optical depth estimate, for each of the plurality of surface points of the subject. In one embodiment, the output returned includes a weighted average of the ToF depth estimate and the stereo-optical depth estimate. In embodiments in which the ToF uncertainty is available, the relative weight of ToF and stereo-optical depth estimates may be adjusted based on the uncertainty, in order to provide a more accurate output for the current surface point: more accurate ToF estimates are weighted more heavily, and less accurate ToF estimates are weighted less heavily. In some embodiments, the ToF estimate may be ignored completely if the uncertainty or depth distribution indicates that multiple reflections have contaminated the ToF estimate in the vicinity of the current surface point. In still other embodiments, returning the output, at 86, may include using the stereo-optical estimate to filter noise from phase-responsive pixels corresponding to the searched subset of intensity-responsive pixels of the first imaging array. In other words, the stereo-optical depth measurement can be used selectively—i.e., in areas of the ToF image corrupted by excessive noise—and omitted in areas where the ToF noise is not excessive. This strategy may be used to economize overall compute effort.

As evident from the foregoing description, the methods and processes described herein may be tied to a compute system of one or more computing machines—e.g., ToF driver 48, left camera driver 65, stereo-optical driver 38, and image receiver 20 of FIG. 1. Such methods and processes may be implemented as a computer-application program or service, an application-programming interface (API), a library, and/or other computer-program product. Each computing machine may include a logic machine 90, associated computer-memory machine 92, and a communication machine 94 (shown explicitly for image receiver 20 and present in the other computing machines as well).

Each logic machine 90 includes one or more physical logic devices configured to execute instructions. A logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

A logic machine 90 may include one or more processors configured to execute software instructions. Additionally or alternatively, a logic machine may include one or more hardware or firmware logic machines configured to execute hardware or firmware instructions. Processors of a logic machine may be single-core or multi-core, and the instructions executed thereon may be configured for sequential, parallel, and/or distributed processing. Individual components of a logic machine optionally may be distributed among two or more separate devices, which may be remotely located and/or configured for coordinated processing. Aspects of a logic machine may be virtualized and executed by remotely accessible, networked computing devices configured in a cloud-computing configuration.

Computer-memory machine 92 includes one or more physical, computer-memory devices configured to hold instructions executable by an associated logic machine 90 to implement the methods and processes described herein. When such methods and processes are implemented, the state of the computer-memory machine may be transformed—e.g., to hold different data. A computer-memory machine may include removable and/or built-in devices; it may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. A computer-memory machine may include volatile, nonvolatile, dynamic, static, read/write, read-only, random-access, sequential-access, location-addressable, file-addressable, and/or content-addressable devices.

It will be appreciated that computer-memory machine 92 includes one or more physical devices. However, aspects of the instructions described herein alternatively may be propagated by a communication medium (e.g., an electromagnetic signal, an optical signal, etc.), as opposed to being stored via a storage medium.

Aspects of logic machine 90 and computer-memory machine 92 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms ‘module’, ‘program’, and ‘engine’ may be used to describe an aspect of a computer system implemented to perform a particular function. In some cases, a module, program, or engine may be instantiated via a logic machine executing instructions held by a computer-memory machine. It will be understood that different modules, programs, and engines may be instantiated from the same application, service, code block, object, library, routine, API, function, etc. Likewise, the same module, program, or engine may be instantiated by different applications, services, code blocks, objects, routines, APIs, functions, etc. A module, program, or engine may encompass individual or groups of executable files, data files, libraries, drivers, scripts, database records, etc.

Optionally, a communication machine 94 may be configured to communicatively couple the compute system to one or more other machines, including server computer systems. The communication machine may include wired and/or wireless communication devices compatible with one or more different communication protocols. As non-limiting examples, a communication machine may be configured for communication via a wireless telephone network, or a wired or wireless local- or wide-area network. In some examples, a communication machine may allow a computing machine to send and/or receive messages to and/or from other devices via a network such as the Internet.

It will be understood that the configurations and/or approaches described herein are exemplary in nature, and that these specific examples or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

This disclosure is directed to an imaging system comprising first and second imaging arrays, a modulated light source, and first and second drivers. The first imaging array includes a plurality of phase-responsive pixels distributed among a plurality of intensity-responsive pixels. The modulated light source is configured to emit modulated light in a field of view of the first imaging array. The first driver is configured to modulate the light and synchronously control charge collection from the phase-responsive pixels to furnish a time-of-flight depth estimate. The second imaging array is an array of intensity-responsive pixels arranged a fixed distance from the first imaging array. The second driver is configured to recognize disparity between the intensity-responsive pixels of the first imaging array and corresponding intensity-responsive pixels of the second imaging array to furnish a stereo-optical depth estimate.

The imaging system outlined above may further comprise a structured light source configured to emit structured light in a field of view of the second imaging array. The imaging system may further comprise first and second objective lens systems arranged forward of the first and second imaging arrays, respectively, and configured so that the first and second imaging arrays have overlapping fields of view. In some implementations of the imaging system, the plurality of phase-responsive pixels are arranged in parallel rows of contiguous phase-responsive pixels, between intervening, mutually parallel rows of contiguous intensity-responsive pixels. In this and other implementations, a group of contiguous phase-responsive pixels of a given row is addressed concurrently to provide plural charge storages for the group. In this and other implementations, parallel rows may be arranged vertically or horizontally. In this and other implementations, the intensity-responsive pixels of the first imaging array may be included only in portions of the first imaging array that image an overlap between fields of view of the first and second imaging arrays.

The imaging system outlined above may further comprise a dual-passband optical filter arranged forward of the first imaging array and configured to transmit visible light and to block infrared light outside of an emission band of the modulated light source. In some implementations of the imaging system, each phase-responsive pixel includes an optical filter layer configured to block wavelengths outside an emission band of the modulated light source. In these and other implementations, the intensity-responsive pixels of the second imaging array may include red-, green-, and blue-transmissive filter elements. The modulated light source may be an infrared light source, for example.

This disclosure is also directed to a depth-sensing method enacted in an imaging system having a modulated light source and first and second imaging arrays separated by a fixed distance and configured to image a subject. The method comprises acts of: modulating emission from the modulated light source and synchronously controlling charge collection from phase-responsive pixels of the first imaging array to furnish a time-of-flight depth estimate for each of a plurality of surface points of the subject; recognizing disparity between intensity-responsive pixels of the first imaging array and corresponding intensity-responsive pixels of the second imaging array to furnish a stereo-optical depth estimate for each of the plurality of surface points of the subject; and returning an output based on the time-of-flight depth estimate and on the stereo-optical depth estimate for each of the plurality of surface points of the subject.

In some implementations of the above method, the output includes a weighted average of the time-of-flight depth estimate and the stereo-optical depth estimate for each of the plurality of surface points of the subject. The method may further comprise computing an uncertainty in the time-of-flight depth estimate for a given surface point of the subject, and adjusting, based on the uncertainty, a relative weight in the weighted average associated with that surface point. In this and other implementations, the method may further comprise omitting the stereo-optical depth estimate for the given point if the uncertainty is below a threshold. In these and other implementations, the plurality of surface points may be points illuminated by structured light from a structured light source of the imaging system. In these and other implementations, the plurality of surface points may be feature points automatically recognized in image data from the intensity-responsive pixels of the first and second image arrays.

This disclosure is also directed to another depth-sensing method enacted in an imaging system having a modulated light source and first and second imaging arrays separated by a fixed distance and configured to image a subject. This method comprises acts of: modulating emission from the modulated light source and synchronously controlling charge collection from phase-responsive pixels of the first imaging array to furnish a time-of-flight depth estimate for each of a plurality of surface points of the subject; searching subsets of intensity-responsive pixels of the first and second imaging arrays to identify corresponding pixels, the searched subsets being selected based on the time-of-flight depth estimate; recognizing disparity between the intensity-responsive pixels of the first imaging array and the corresponding intensity-responsive pixels of the second imaging array to furnish a stereo-optical depth estimate for each of the plurality of surface points of the subject; and returning an output based on the time-of-flight depth estimate and on the stereo-optical depth estimate for each of the plurality of surface points of the subject. In some implementations, the above method may further comprise computing an uncertainty in the time-of-flight depth estimate for each surface point of the subject, wherein the computed uncertainty determines a size of the searched subset corresponding to that point. In these and other implementations, returning the output based on the time-of-flight depth estimate and on the stereo-optical depth estimate may include using the stereo-optical estimate to filter noise from phase-responsive pixels corresponding to the searched subset of intensity-responsive pixels of the first imaging array.

The subject matter of the present disclosure includes all novel and non-obvious combinations and sub-combinations of the various processes, systems and configurations, and other features, functions, acts, and/or properties disclosed herein, as well as any and all equivalents thereof.

1. An imaging system comprising:
a first imaging array including a plurality of phase-responsive pixels distributed among a plurality of intensity-responsive pixels;
a modulated light source configured to emit modulated light in a field of view of the first imaging array;
a first driver configured to modulate the light and synchronously control charge collection from the phase-responsive pixels to furnish a time-of-flight depth estimate;
a second imaging array of intensity-responsive pixels, the second imaging array arranged a fixed distance from the first imaging array; and
a second driver configured to recognize disparity between the intensity-responsive pixels of the first imaging array and corresponding intensity-responsive pixels of the second imaging array to furnish a stereo-optical depth estimate.

2. The imaging system of claim 1, further comprising a structured light source configured to emit structured light in a field of view of the second imaging array.

3. The imaging system of claim 1, further comprising first and second objective lens systems arranged forward of the first and second imaging arrays, respectively, and configured so that the first and second imaging arrays have overlapping fields of view.

4. The imaging system of claim 1, wherein the plurality of phase-responsive pixels are arranged in parallel rows of contiguous phase-responsive pixels, between intervening, mutually parallel rows of contiguous intensity-responsive pixels.

5. The imaging system of claim 4, wherein a group of contiguous phase-responsive pixels of a given row is addressed concurrently to provide plural charge storages for the group.

6. The imaging system of claim 4, wherein the parallel rows are arranged vertically.

7. The imaging system of claim 4, wherein the parallel rows are arranged horizontally.

8. The imaging system of claim 1, wherein the intensity-responsive pixels of the first imaging array are included only in portions of the first imaging array that image an overlap between fields of view of the first and second imaging arrays.

9. The imaging system of claim 1, further comprising a dual-passband optical filter arranged forward of the first imaging array and configured to transmit visible light and to block infrared light outside of an emission band of the modulated light source.

10. The imaging system of claim 1, wherein each phase-responsive pixel includes an optical filter layer configured to block wavelengths outside an emission band of the modulated light source.

11. The imaging system of claim 1, wherein the intensity-responsive pixels of the second imaging array include red-, green-, and blue-transmissive filter elements, and wherein the modulated light source is an infrared light source.

12. A depth-sensing method enacted in an imaging system having a modulated light source and first and second imaging arrays separated by a fixed distance and configured to image a subject, the method comprising:
modulating emission from the modulated light source and synchronously controlling charge collection from phase-responsive pixels of the first imaging array to furnish a time-of-flight depth estimate for each of a plurality of surface points of the subject;
recognizing disparity between intensity-responsive pixels of the first imaging array and corresponding intensity-responsive pixels of the second imaging array to furnish a stereo-optical depth estimate for each of the plurality of surface points of the subject; and
returning an output based on the time-of-flight depth estimate and on the stereo-optical depth estimate for each of the plurality of surface points of the subject.

13. The method of claim 12, wherein the output includes a weighted average of the time-of-flight depth estimate and the stereo-optical depth estimate for each of the plurality of surface points of the subject.

14. The method of claim 13, further comprising computing an uncertainty in the time-of-flight depth estimate for a given surface point of the subject, and adjusting, based on the uncertainty, a relative weight in the weighted average associated with that surface point.

15. The method of claim 14, further comprising omitting the stereo-optical depth estimate for the given point if the uncertainty is below a threshold.

16. The method of claim 12, wherein the plurality of surface points are points illuminated by structured light from a structured light source of the imaging system.

17. The method of claim 12, wherein the plurality of surface points are feature points automatically recognized in image data from the intensity-responsive pixels of the first and second image arrays.

18. A depth-sensing method enacted in an imaging system having a modulated light source and first and second imaging arrays separated by a fixed distance and configured to image a subject, the method comprising:
modulating emission from the modulated light source and synchronously controlling charge collection from phase-responsive pixels of the first imaging array to furnish a time-of-flight depth estimate for each of a plurality of surface points of the subject;
searching subsets of intensity-responsive pixels of the first and second imaging arrays to identify corresponding pixels, the searched subsets being selected based on the time-of-flight depth estimate;
recognizing disparity between the intensity-responsive pixels of the first imaging array and the corresponding intensity-responsive pixels of the second imaging array to furnish a stereo-optical depth estimate for each of the plurality of surface points of the subject; and
returning an output based on the time-of-flight depth estimate and on the stereo-optical depth estimate for each of the plurality of surface points of the subject.

19. The method of claim 18, further comprising computing an uncertainty in the time-of-flight depth estimate for each surface point of the subject, wherein the computed uncertainty determines a size of the searched subset corresponding to that point.

20. The method of claim 18, wherein returning the output based on the time-of-flight depth estimate and on the stereo-optical depth estimate includes using the stereo-optical estimate to filter noise from phase-responsive pixels corresponding to the searched subset of intensity-responsive pixels of the first imaging array.
